(19) United States
(12) Patent Application Publication
(10) Pub. No.: US 2009/0092402 A1
(43) Pub. Date: Apr. 9, 2009

(54) IMAGE FORMING APPARATUS AND IMAGE FORMING METHOD

(75) Inventor: Takayuki Mizuno, Mishima-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/867,322

(22) Filed: Oct. 4, 2007

(51) Int. Cl. G03G 15/08

(52) U.S. Cl. 399/27

(57) ABSTRACT

An image forming apparatus which forms an image and exchanges information to and from an external apparatus includes a replacement detection unit to detect that a consumable constituting the image forming apparatus is replaced, a temporary information storage unit to store, when the replacement detection unit detects that the consumable is replaced, replacement achievement information of the consumable as temporary information indicating that the replacement is temporary into a storage unit, and a formal information storage unit to store, when a specified condition is established, the temporary information as formal information indicating that the replacement is confirmed into the storage unit.

### BACKGROUND OF THE INVENTION

1. Field of the Invention

The present invention relates to a technique to properly grasp the replacement date of each part in order to create a maintenance plan of a product including plural parts.

2. Description of the Related Art

In an image forming apparatus such as a printer or a facsimile, replacement parts such as a photoconductive drum and toner are used. Hitherto, the replacement timing of these replacement parts is determined based on the experience and intuition of a service man. Thus, there has been a problem that prediction accuracy of the replacement timing is low.

Then, information relating to the consumption degree of each replacement part of an image forming apparatus is transmitted to an external service center by using external communication means provided in the image forming apparatus. At the service center, the replacement timing of each replacement part is predicted based on the transmitted information, and a maintenance plan of the product is created (JP-A-7-246758, JP-A-11-179971).

### BRIEF SUMMARY OF THE INVENTION

According to a first aspect of the invention, an image forming apparatus which forms an image and exchanges information to and from an external apparatus includes a replacement detection unit to detect that a consumable constituting the image forming apparatus is replaced, a temporary information storage unit to store, when the replacement detection unit detects that the consumable is replaced, replacement achievement information of the consumable as temporary information indicating that the replacement is temporary into a storage unit, and a formal information storage unit to store, when a specified condition is established, the temporary information as formal information indicating that the replacement is confirmed into the storage unit.

According to a second aspect of the invention, an image forming method of an image forming apparatus which forms an image and exchanges information to and from an external apparatus includes a replacement detection step of detecting that a consumable constituting the image forming apparatus is replaced, a temporary information storage step of storing, when it is detected at the replacement detection step that the consumable is replaced, replacement achievement information of the consumable as temporary information indicating that the replacement is temporary into a storage unit, and a formal information storage step of storing, when a specified condition is established, the temporary information as formal information indicating that the replacement is confirmed into the storage unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a rough shape of an image forming apparatus to which the invention can be applied.

FIG. 2 is a block diagram showing a structure of a copy function of an MFP.

FIG. 3 is a block diagram showing a structural example of the MFP.

FIG. 4 is a system structural view showing the outline of a maintenance method using the MFP.

FIG. 5 is a flow diagram showing a rough processing procedure of a case where toner replacement is performed by a user.

FIG. 6 is a view showing the content of a replacement history information table.

FIG. 7 is a flow diagram showing a rough processing procedure at a normal time when abnormality does not occur.

### DETAILED DESCRIPTION OF THE INVENTION

Hereinafter, an embodiment of the invention will be described while an image forming apparatus (MFP: Multi Function Peripheral) 201 is used as an example.

The MFP 201 is a digital multifunction machine for comprehensively using functions of various office equipments, such as an image reception function of a FAX, an image reception function of E mail, and a print image reception function of a network, in addition to scanning, reading and copying an image with a specified resolution and sheet size.

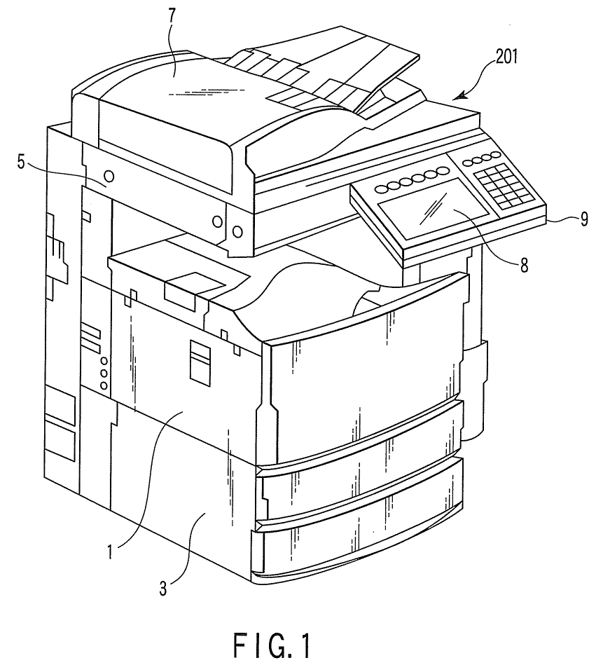

FIG. 1 is a perspective view showing a rough shape of the image forming apparatus to which the invention can be applied.

The MFP 201 includes a print unit 1, a sheet tray 3, a scan unit 5, an auto feed unit 7 and an operation panel 9 provided with an LCD 8.

The print unit 1 outputs image information as an output image called a hard copy or a printout. The sheet tray 3 supplies an output medium as a sheet of an arbitrary size used for image output to the print unit 1. The scan unit 5 captures image information as image data from an original document. The auto feed unit 7 sends the original document whose reading is completed from a read position to a discharge position, and guides a next original document to the read position. The operation panel 9 is an instruction input unit for instructing an operation of the MFP 201, such as a start of image formation in the print unit 1 or a start of reading of the image information of the original document by the scan unit 5. The operation panel 9 is provided with the LCD 8 for inputting instructions and displaying information to the operator.

Further, the MFP 201 is connected to a not-shown network and a communication line and can receive image data by FAX, Email or the like.

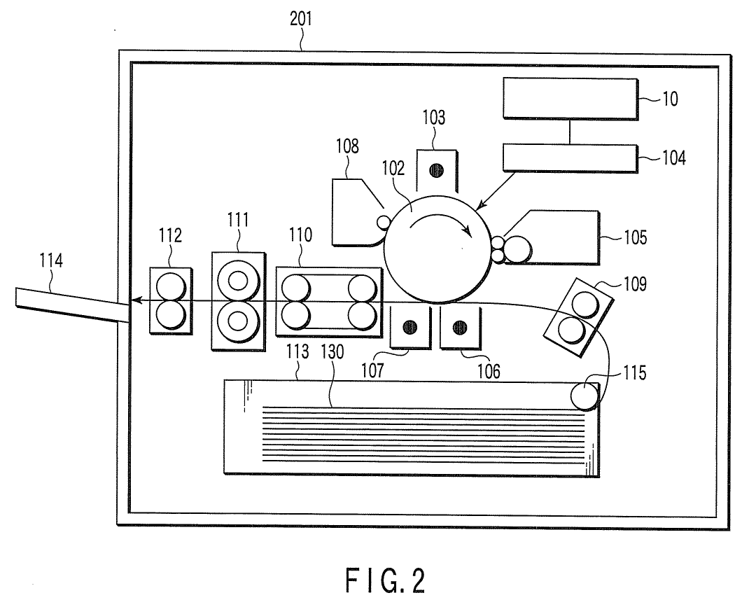

FIG. 2 is a block diagram showing a structure of a copy function of the MFP 201.

The MFP 201 includes a control unit 10, a photoconductive drum 102, a charging unit 103, a scanning exposure unit 104, a developing unit 105, a transfer charger 106, a peel charger 107, a cleaner 108, a paper feed unit 109, a sheet transport unit 110, a fixing unit 111, a paper discharge unit 112 and a paper discharge tray 114.

The photoconductive drum 102 rotates in a sub-scanning direction as a peripheral direction of the photoconductive drum 102. The charging unit 103 is disposed in the vicinity of the periphery of the photoconductive drum 102. The charging unit 103 uniformly charges the surface of the photoconductive drum 102. The scanning exposure unit 104 turns on/off a light according to an image signal while scanning a semiconductor laser in the scanning exposure unit 104. The laser light emitted from the semiconductor laser becomes the light scanning in a main scanning direction as a rotation axis direction of the photoconductive drum 102 by a deflector such as a polygon mirror. The laser light is irradiated onto the photoconductive drum 102 by an optical system such as a lens. When the laser light is irradiated to the charged photoconductive drum 102, the potential of an irradiated part is reduced and an electrostatic latent image is formed.

The developing unit 105 applies a developer to the photoconductive drum 102 to form a toner image on the photoconductive drum 102. On the other hand, the sheet tray 3 is provided at the bottom of the MFP 201. A paper feed roller 115 separates sheets 130 in the sheet tray 3 one by one and sends them to the paper feed unit 109. The paper feed unit 109 supplies the sheet 130 to the transfer position of the photoconductive drum 102. The transfer charger 106 transfers the toner image to the supplied sheet 130. The peel charger 107 peels the sheet 130 from the photoconductive drum 102.

The sheet 130 on which the toner image is transferred is transported by the sheet transport unit 110. The fixing unit 111 fixes the toner image to the sheet 130. The paper discharge unit 112 discharges the sheet 130 on which the image is printed to the paper discharge tray 114.

After the transfer of the toner image to the sheet 130 is completed, a residual toner on the photoconductive drum 102 is removed by the cleaner 108. The photoconductive drum 102 returns to the initial state and is put in a waiting state of next image formation.

The image formation operation is continuously performed by repeating the above process operation.

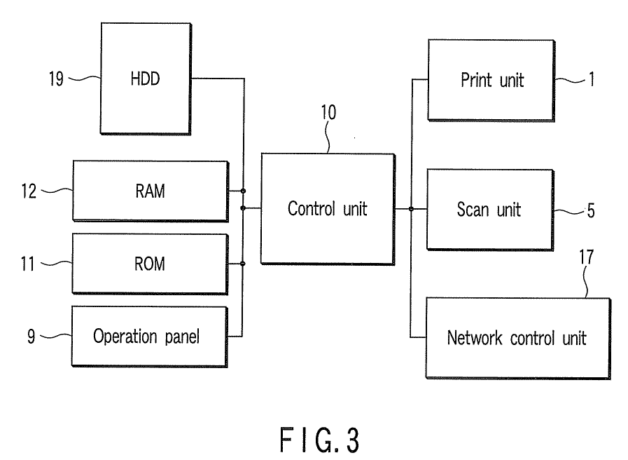

FIG. 3 is a block diagram showing a structural example of the MFP 201.

The MFP 201 further includes a control unit 10, a ROM 11, a RAM 12, a network control unit 17 and an inner storage device (HDD) 19 as well as the print unit 1, the sheet tray 3, the scan unit 5, the LCD 8 and the operation panel 9. The respective parts are connected through a system bus.

The control unit 10 controls the respective hardware parts connected through the system bus. The ROM 11 stores various control programs necessary for the MFP 201 to operate. The RAM 12 is a buffer memory to temporarily store data generated at the time of execution of a control program.

The network control unit 17 is an interface for exchanging information through a network such as the Internet. The HDD 19 is a nonvolatile storage medium installed inside the MFP 201. The HDD 19 records history information relating to part replacement.

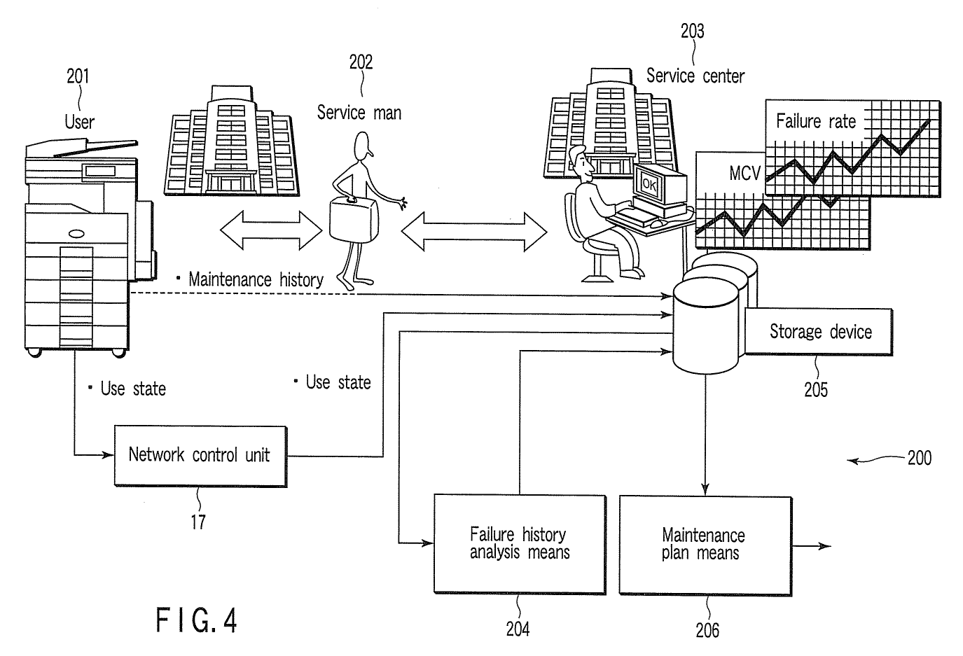

FIG. 4 is a system structural view showing the outline of a maintenance method using the MFP of the embodiment of the invention.

Plural service men 202 maintain plural MFPs 201 installed at plural users while one service center 203 is used as a base.

Related art maintenance methods include a preventive maintenance (PM) and an emergency maintenance (EM). In the PM, the service man 202 visits the MFP 201 as the maintenance object at a periodic timing set for each MFP and performs replacement of consumables, cleaning, and operation confirmation of the MFP 201. In the EM, in the case where a failure accidentally occurs, a service call from the user is received and a visit is made for the repair of the MFP 201.

At the time of completion of the work, the service man 202 transmits maintenance history data to a maintenance plan system 200 provided in the service center 203 through the network control unit 17 of the MFP 201. When the MFP 201 has no communication function, the service man 202 returns to the service center 203 and inputs maintenance history data to the maintenance plan system 200 from a working record summarized as a report of the maintenance work. The maintenance history data is stored in a storage means 205.

Besides, at a set periodic communication time (for example, 10 o'clock every day), the MFP 201 transmits data relating to the use state to the maintenance plan system 200. The data relating to the use state are stored in the storage means 205.

In the maintenance plan system 200, a failure history analysis means 204 calculates a failure rate distribution by using Weibull distribution for each consumable based on the past maintenance history data, and performs failure prediction based on the failure rate distribution. A maintenance plan means 206 calculates a next visit time and a list of consumables to be replaced at that time from the data relating to the use state of the MFP 201 collected through the network control unit 17.

From the viewpoint of preventing a failure from occurring and keeping the reliability of the MFP 201 by shortening a failure time, it is considered to be desirable that with respect to a consumable such as toner, the user can voluntarily replace it without replying on the service man 202. Thus, with respect to a specified consumable, a mechanism is designed so that the user can easily replace it, it is automatically detected that the consumable is replaced, and maintenance history data indicating the replacement is automatically transmitted to the maintenance plan system 200.

However, in the case where the MFP 201 is constructed as stated above, it is necessary to prevent erroneous data from being transmitted to the maintenance plan system 200. Since the user who performs the replacement work is not always a skilled person differently from the service man 202, it is not ensured that the replacement is certainly performed in an expected state. Further, in the case where erroneous maintenance history data is transmitted, the accuracy of a maintenance plan created by the maintenance plan system 200 is reduced, and the reliability of the service center 203 and the MFP 201 is reduced.

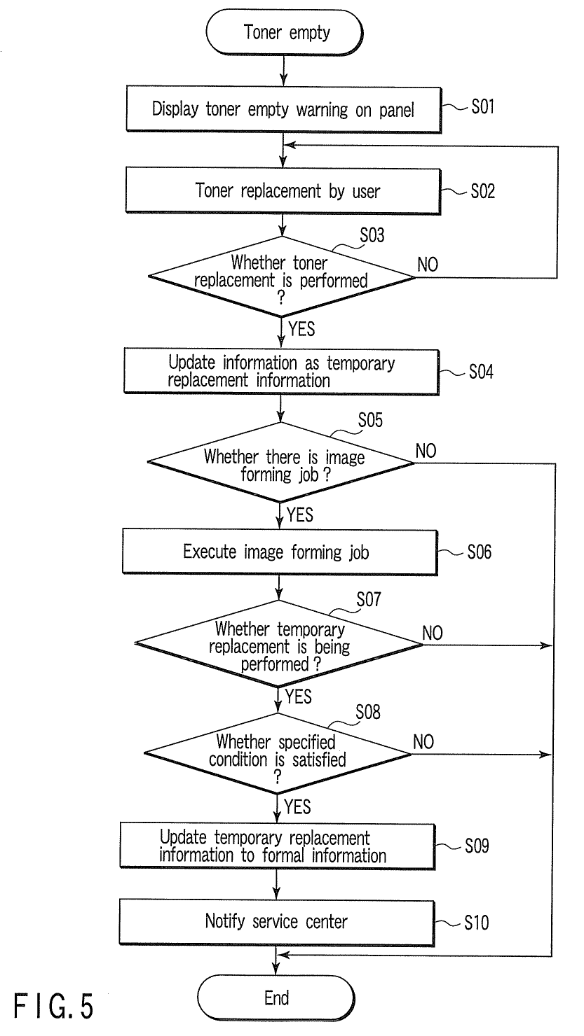

FIG. 5 is a flow diagram showing a rough processing procedure of a case where toner replacement is performed by the user. The control unit 10 of the MFP 201 performs a relevant program and this processing is realized.

In the case where the MFP 201 detects toner empty, at step S01, the control unit 10 displays a warning of the toner empty on the LCD 8 of the operation panel 9, and urges the user to replace. Incidentally, the toner empty may be informed to an administrator by using communication means via electronic mail.

At step S02, the process waits for the replacement of toner is performed by the user. When the user takes out an empty cartridge and sets a new cartridge, the MFP 201 automatically detects that the toner is replaced. At step S03, it is checked whether it is detected that the toner replacement is performed. In the case of Yes at step S03, that is, in the case where the MFP 201 detects the toner replacement, at step S04, a replacement history information table 30 stored in the HDD 19 is updated.

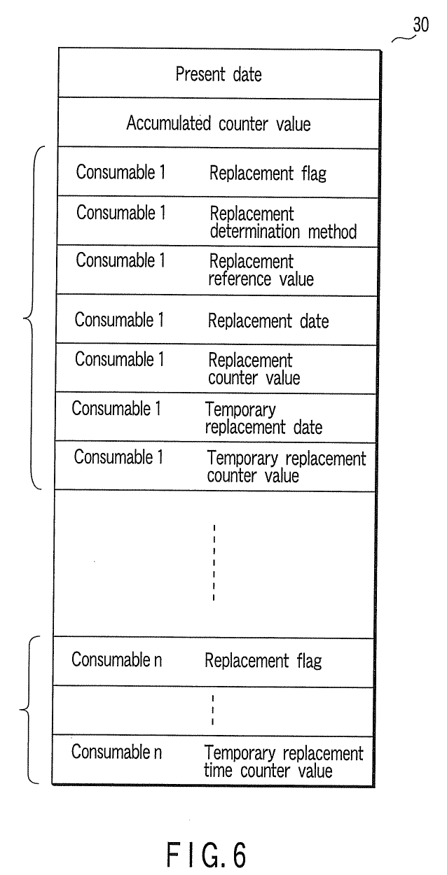

FIG. 6 is a view showing the content of the replacement history information table 30.

The replacement history information table 30 includes “present date”, “accumulated counter value”, “consumable replacement flag”, “consumable replacement determination method”, “consumable replacement reference value”, “consumable replacement date”, “consumable replacement time counter value”, “consumable temporary replacement date”, and “consumable temporary replacement time counter value”. Incidentally, the “consumable replacement flag” to the “consumable temporary replacement time counter value” are provided for each consumable.

The present year, month, day and time are stored in the “present date”. The accumulation of counter values as the number of times of copying in the MFP 201 is recorded in the “accumulated counter value”. Incidentally, A4 copy/print is counted as 1, A3 copy/print is counted as 2, and the counter value represents how many sheets in A4 size are outputted.

The “consumable replacement flag” is a flag to indicate that the replacement of the relevant consumable is in a temporary state. That is, in a state where the replacement is not confirmed, the flag is set to ON, and when the replacement is confirmed, the flag is set to OFF. The “consumable replacement determination method” represents a condition used for confirming the replacement of the consumable. For example, when it is “0”, a counter value is used for a conditional expression of determination. When it is “1”, a date is used for the conditional expression of determination. The “consumable replacement reference value” represents a threshold value for confirmation of the replacement of the consumable.

A confirmed value of the date when the consumable is replaced is stored in the “consumable replacement date”. A confirmed value of the counter value when the consumable is replaced is stored in the “consumable replacement time counter value”. The date when the user replaces the consumable is stored in the “consumable temporary replacement date”. The counter value at the time when the consumable is replaced by the user is stored in the “consumable temporary replacement time counter value”.

Incidentally, in the replacement history information table 30 of FIG. 6, although not shown in the drawing, past history information relating to the replacement of consumables is recorded.

Referring back to FIG. 5, at step S04, the control unit 10 turns ON the “consumable replacement flag” of the relevant consumable of the replacement history information table 30. The present date and the present counter value of the MFP 201 are stored in the “consumable temporary replacement date” and the “consumable temporary replacement time counter value”, respectively.

At step S05, it is checked whether there is an image forming job being executed at present. In the case of Yes at step S05, that is, in the case where there is an image forming job being executed at present, at step S06, the image forming job is executed and the process proceeds to step S07. In the case of No at step S05, that is, in the case where there is no image forming job being executed at present, the process proceeds to END without executing a subsequent processing.

At step S07, it is checked whether the relevant consumable is being temporarily replaced. In the case of Yes at step S07, that is, in the case where the “consumable replacement flag” of the relevant consumable in the replacement history information table 30 is “ON”, at step S08, it is checked whether the specified condition for confirming the replacement of the consumable is satisfied.

For example, when the “consumable replacement determination method” is “0”, it is checked whether (“accumulated counter value”—“consumable temporary replacement time counter value”) exceeds the counter value of “consumable replacement reference value”. When the “consumable replacement determination method” is “1”, it is checked whether (“present date”—“consumable temporary replacement date”) exceeds the date of the “consumable replacement reference value”.

In the case of Yes at step S08, that is, in the case where the specified condition is satisfied, at step S09, the temporary replacement information is updated to formal information. That is, the “consumable replacement flag” is turned “OFF”, and the “consumable temporary replacement date” and the “consumable temporary replacement time counter value” are copied to the “consumable replacement date” and the “consumable replacement time counter value”, respectively. At step S10, the “consumable replacement date” and the “consumable replacement time counter value”, together with information to specify the relevant consumable, are transmitted to the maintenance plan system 200 of the service center 203.

Here, in the case of No at step S05, that is, in the case where there is no image forming job being executed at present, the processing subsequent to step S07 is not executed because the process proceeds to END without executing the subsequent processing. Thereafter, the processing subsequent to step S07 is executed when an image forming job is executed in a normal state in which abnormality does not occur.

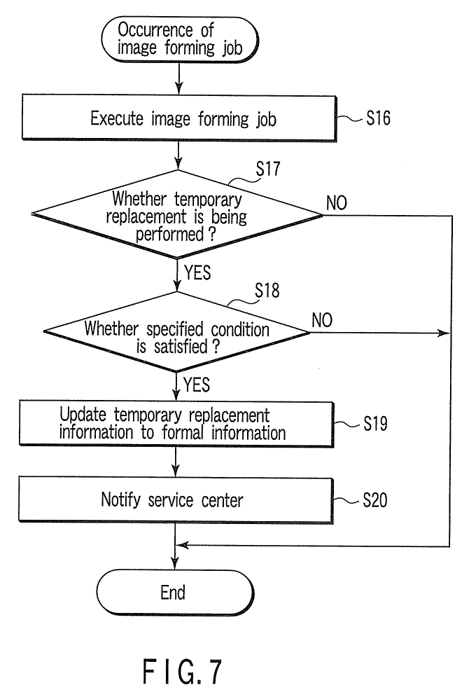

FIG. 7 is a flow diagram showing a rough processing procedure of a case where an image forming job is executed in a normal state where abnormality does not occur.

When the image forming job occurs, at step S16, the image forming job is executed, and the process proceeds to step S17.

At step S17, it is checked whether the relevant consumable is being temporarily replaced. In the case of Yes at step S17, that is, in the case where the “consumable replacement flag” of the relevant consumable in the replacement history information table 30 is “ON”, at step S18, it is checked whether a specified condition for confirming the replacement of the relevant consumable is satisfied. Since the processing of step S18 is similar to the processing of step S08, its explanation will be omitted.

Then, in the case of Yes at step S18, that is, in the case where the specified condition is satisfied, at step S19, the temporary replacement information is updated to formal information. Since the processing of step S19 is similar to the processing of step S09, its explanation will be omitted.

At step S10, the “consumable replacement date” and the “consumable replacement time counter value”, together with information to specify the relevant consumable, are transmitted to the maintenance plan system 200 of the service center 203.

### Second Embodiment

Next, a second embodiment of the invention will be described.

This embodiment is a modified example of the first embodiment, and its basic system structure is the same. Hereinafter, the same portion as the portion already explained in the first embodiment is denoted by the same reference numeral and its explanation will be omitted.

In this embodiment, an MFP 201 includes a cartridge in which a photoconductive drum 102, a charging unit 103, a cleaner 108, a developing unit 105 and the like are integrally unitized, and the cartridge can be attached to and detached from a main body.

In the cartridge in which various parts are integrated as stated above, when any one of the parts constituting the cartridge is broken, the necessity of replacement is caused. Then, in this embodiment, the cartridge is regarded as one part and is handled.

Differing from the first embodiment, the MFP 201 does not include means for detecting the life of the cartridge. Then, at the time of periodic communication, the MFP 201 downloads information of “cartridge replacement date” stored in storage means 205 of a maintenance plan system 200, and displays a message of cartridge replacement on an operation panel 9 provided in the MFP 201. The procedure of cartridge replacement work by the user subsequent to this is the same as that of the first embodiment.

Since the detachment and attachment of the cartridge are easy, the user can replace it, and it is desirable that the replacement of a consumable whose replacement is easy as stated above is performed at the user side to the extent possible from the viewpoint of the cost of maintenance work and the improvement of efficiency.

By this, maintenance work can be arranged such that, with respect to a consumable which can be replaced at the user side, but the replacement work is performed at the user side without being visited by a service man 202, and with respect to a consumable whose replacement is difficult at the user side, the service man 202 visits, whereby the working efficiency of maintenance work can be improved, and further, the accuracy of a maintenance plan can be kept.

According to the embodiment described above, even in the case where the user temporarily detaches a consumable and again attaches a consumable, it is possible to prevent that erroneous replacement information is adopted.

For example, when a warning of toner empty is issued, there is a case where a small amount of toner remains in the cartridge. Then, there is a case where printing becomes possible when the cartridge is set again after it is shaken. At this time, there has been a fear that in the MFP 201, it is determined that a new cartridge is set, update of information such as replacement date is immediately performed, and erroneous replacement information is transmitted to the maintenance plan system 200.

According to this embodiment, in the case where a sufficient number of times or more is counted by the print counter, or a specified period has passed, it is determined that the toner cartridge is normally replaced, and the temporary replacement date is made the formal replacement date. When the update of the normal replacement date is performed, the information is transmitted to the service center 203.

By this, the maintenance plan system 200 calculates a next replacement scheduled date based on the correct replacement information, so that it becomes possible to accurately calculate the predicted date, and the improvement of maintenance plan accuracy can be expected.

According to the procedure of the embodiment, in the case where the toner empty is detected again before the number of times reaches a specified value, the user is again urged to replace, and the point of time can be again set as the temporary replacement date.

Incidentally, in this embodiment, although the description has been made while using the toner replacement as an example, the invention can be applied to replacement of a consumable other than toner.

Besides, even in the case where the MFP 201 does not have the function to detect the life of the consumable or the consumption state, information relating to the life of the consumable or the consumption state is acquired from the service center, and measures can be taken.

Incidentally, in this embodiment, although the maintenance method uses the MFP 201 and the maintenance plan system 200, the maintenance plan system 200 may not be used, and the MFP 201 may have the function of the maintenance plan system 200.

Further, various methods may be applied to the life prediction of each consumable. In this embodiment, although the life prediction is performed based on the failure rate distribution using the Weibull distribution, a method other than the Weibull distribution may be used. Besides, the life may be directly calculated by arithmetic operation from the past failure history information.

Besides, the invention can be applied to an apparatus other than the image forming apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus which forms an image and exchanges information to and from an external apparatus, comprising:
a replacement detection unit configured to detect that a consumable constituting the image forming apparatus is replaced;
a temporary information storage unit configured to store, when the replacement detection unit detects that the consumable is replaced, replacement achievement information of the consumable as temporary information indicating that the replacement is temporary into a storage unit; and
a formal information storage unit configured to store, when a specified condition is established, the temporary information as formal information indicating that the replacement is confirmed into the storage unit.

2. The image forming apparatus according to claim 1, wherein the replacement achievement information includes at least a replacement date of the consumable and a count value of the image forming apparatus at a time of replacement.

3. The image forming apparatus according to claim 2, wherein the specified condition is established when a specified time has passed since the date when detection was performed by the replacement detection unit, or a present count value is a sum of the count value at the time of the replacement and a count value of a specified number or more.

4. The image forming apparatus according to claim 3, further comprising a history information storage unit configured to store the replacement achievement information from past as history information into the storage unit.

5. The image forming apparatus according to claim 4, further comprising
a life prediction unit configured to predict a life of the consumable based on the history information, and
a display unit configured to display a life prediction result.

6. The image forming apparatus according to claim 3, further comprising:
a consumption state detection unit configured to detect a consumption state of the consumable; and
a display unit configured to display the consumption state.

7. The image forming apparatus according to claim 1, further comprising a transmission unit configured to transmit the replacement achievement information as the formal information to a maintenance plan creation device to create a maintenance plan of the image forming apparatus.

8. The image forming apparatus according to claim 7, wherein
the maintenance plan creation device predicts a life of the consumable, and
the image forming apparatus further comprises:
a reception unit configured to receive a life prediction result of the consumable from the maintenance plan creation device; and
a display unit configured to display the received life prediction result.

9. The image forming apparatus according to claim 1, wherein the consumable includes a cartridge in which plural consumables having different functions are integrally unitized.

10. An image forming method of an image forming apparatus which forms an image and exchanges information to and from an external apparatus, comprising:
a replacement detection step of detecting that a consumable constituting the image forming apparatus is replaced;
a temporary information storage step of storing, when it is detected at the replacement detection step that the consumable is replaced, replacement achievement information of the consumable as temporary information indicating that the replacement is temporary into a storage unit; and
a formal information storage step of storing, when a specified condition is established, the temporary information as formal information indicating that the replacement is confirmed into the storage unit.

11. The image forming method according to claim 10, wherein the replacement achievement information includes at least a replacement date of the consumable and a count value of the image forming apparatus at a time of replacement.

12. The image forming method according to claim 11, wherein the specified condition is established when a specified time has passed since the date when detection was performed by the replacement detection step, or a present count value is a sum of the count value at the time of the replacement and a count value of a specified number or more.

13. The image forming method according to claim 12, further comprising a history information storage step of storing the replacement achievement information from past as history information into the storage unit.

14. The image forming method according to claim 13, further comprising:
a life prediction step of predicting a life of the consumable based on the history information; and
a display step of displaying a life prediction result.

15. The image forming method according to claim 12, further comprising:
a consumption state detection step of detecting a consumption state of the consumable; and
a display step of displaying the consumption state.

16. The image forming method according to claim 10, further comprising a transmission step of transmitting the replacement achievement information as the formal information to a maintenance plan creation device to create a maintenance plan of the image forming apparatus.

17. The image forming method according to claim 16, wherein
the maintenance plan creation device predicts a life of the consumable, and
the image forming step further comprises:
a reception step of receiving a life prediction result of the consumable from the maintenance plan creation device; and
a display step of displaying the received life prediction result.

18. The image forming method according to claim 10, wherein the consumable includes a cartridge in which plural consumables having different functions are integrally unitized.
